(19) United States
(12) Patent Application Publication
(10) Pub. No.: US 2010/0039347 A1
(43) Pub. Date: Feb. 18, 2010

(54) HOUSING FUNCTIONING AS AN ANTENNA AND METHOD FOR FABRICATING THE SAME

(75) Inventors: Hsin-Yi Chen, Tu-Cheng (TW); Yuan-Hsiao Chao, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/494,473

(22) Filed: Jun. 30, 2009

(30) Foreign Application Priority Data
Aug. 15, 2008 (CN) 200810303868.3

(51) Int. Cl. H01Q 1/40; B29C 45/14

(52) U.S. Cl. 343/873; 264/272.11

(57) ABSTRACT

A housing, functioning as an antenna includes an antenna base including two protruding flanges. The housing is formed by injection molding a molten plastic material over and around the antenna base, whereby the antenna base is embedded in the housing, and the protruding flanges are exposed out of the housing. A method for fabricating the housing is also described.

### BACKGROUND

1. Technical Field

The present disclosure relates to a housing functioning as an antenna and a method for fabricating the same.

2. Description of Related Art

Portable electronic devices generally use antennas for receiving and/or sending telecommunication signals. The antenna is usually assembled inside the portable electronic device by way of adhering or hot melting it to a circuit board, which increase costs. Additionally, it can be difficult to arrange the antenna and many other electronic components inside the portable electronic device, if it is desired that the portable electronic device be smaller and more portable.

Therefore, there is room for improvement within the art.

### BRIEF DESCRIPTION OF THE DRAWINGS

Many aspects of the new housing functioning as an antenna and method for fabricating the same can be better understood with reference to the following drawings. The components in the drawings are not necessarily drawn to scale, the emphasis instead being placed upon clearly illustrating the principles of the new housing functioning as an antenna and method for fabricating the same. Moreover, in the drawings, like reference numerals designate corresponding parts throughout the several views.

FIG. 1 is partially cut-away, isometric view of a housing functioning as an antenna of electronic device according to an exemplary embodiment.

FIG. 2 is an isometric view of an antenna base of the housing shown in FIG. 1.

FIG. 3 is an isometric view of a metallic frame for making the antenna base shown in FIG. 2.

FIG. 4 is a partially cut-away view of the housing shown in FIG. 1 during course of fabrication.

FIG. 5 is a partially cut-away view of the housing shown in FIG. 1 including a circuit board installed therein.

FIG. 6 is an enlarged view of area VI shown in FIG. 5.

### DETAILED DESCRIPTION OF THE EMBODIMENT

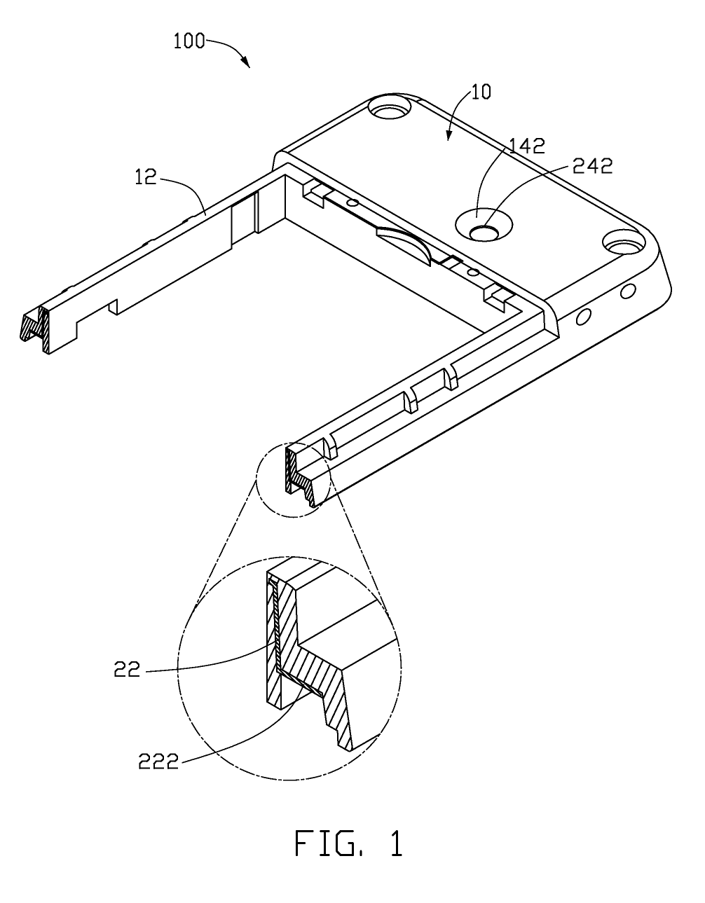

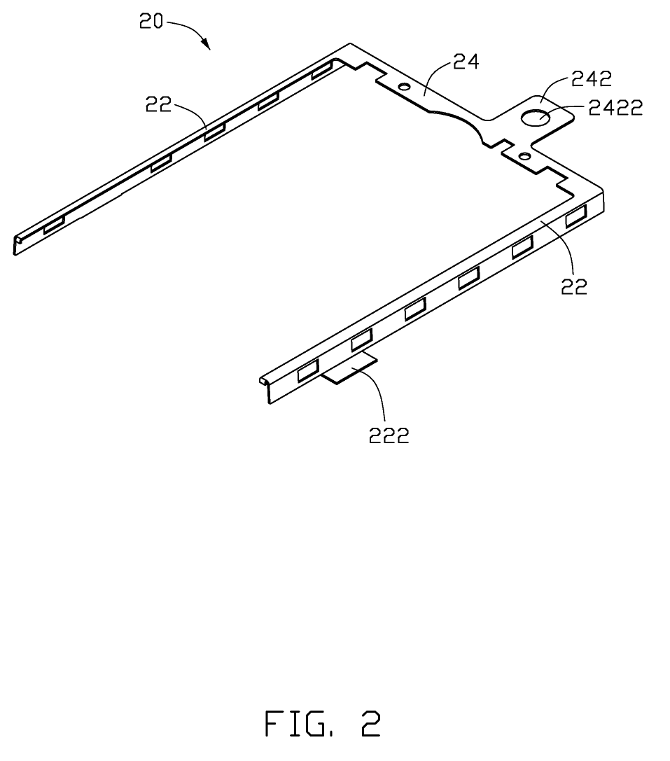

FIG. 1 shows an exemplary housing 10 functioning as an antenna for portable electronic devices, such as mobile phones, etc. FIG. 2 shows an antenna base 20 for embedding within the housing 10.

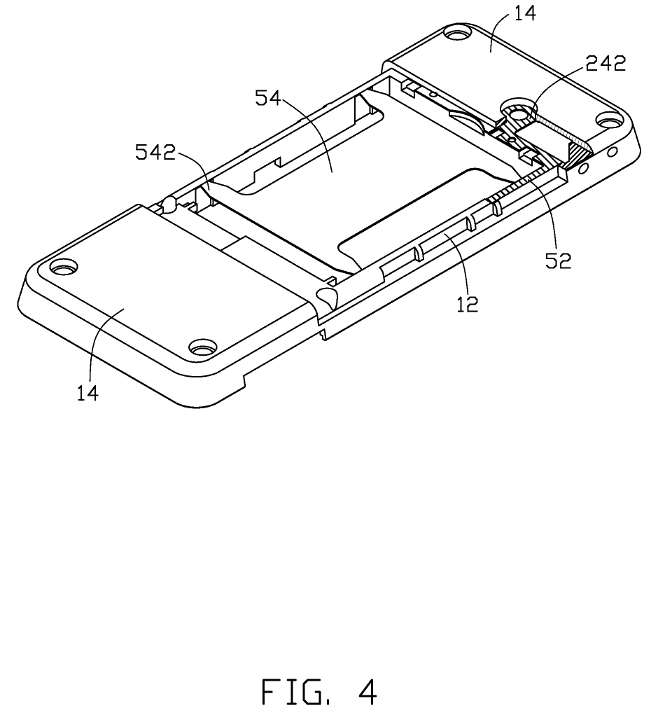

The housing 10 having the antenna base 20 can be molded using plastic material. The housing 10 includes two opposite sidewalls 12 and two opposite end portions 14 (FIG. 4). A hole 142 is defined in one of the end portion 14. The generally U-shaped antenna base 20 includes two opposite extending walls 22 and a connecting wall 24 connecting the two extending walls 22. The two extending walls 22 are embedded into the two sidewalls 12 of the housing 10 respectively. Each of the extending walls 22 has a protruding flange 222 protruding from the exterior lateral surface thereof. The protruding flange 222 is exposed at the bottom of the sidewall 12 when the antenna base 20 is combined into the housing 10. The protruding flange 222 electronically connects to a circuit board of the portable electronic device. The connecting wall 24 is embedded into the end portion 14. The end portion 14 defines a hole 142. The connecting wall 24 has an extending flange 242 extending from its exterior top surface. The extending flange 242 of the antenna base 20 is used to receive and/or send telecommunication signals. The extending flange 242 defines an engaging aperture 2422 in line with the hole 142 of the housing 10 on the condition that the extending flange 242 is embedded in the end portion 14.

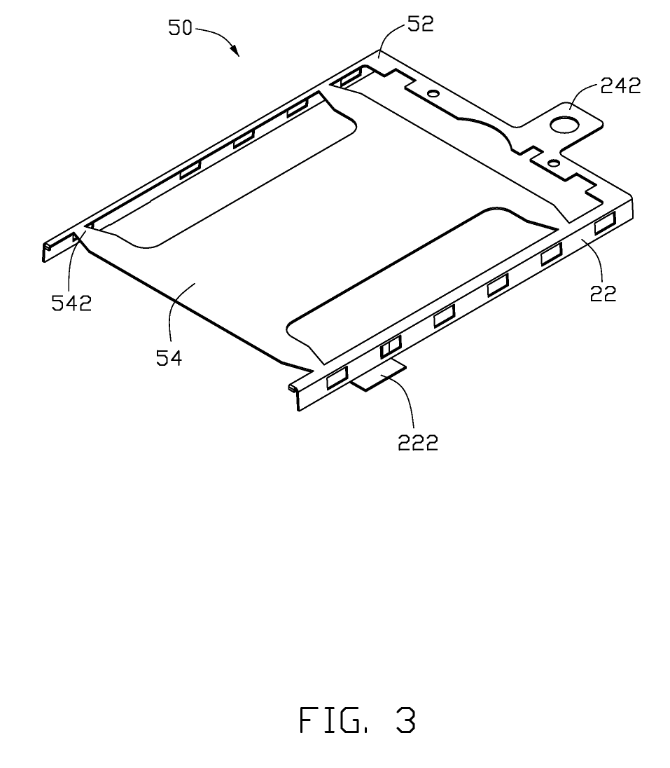

To fabricate the housing 10, referring to FIG. 3, a provided metallic frame 50 includes an antenna base portion 52 for forming the antenna base 20 and a positioning plate 54 connected to the antenna base portion 52. The positioning plate 54 is positioned between the two extending walls 22, and is connected to the two extending walls 22 by connecting points 542. Referring further to FIG. 4, the housing 10 can be fabricated by way of insert-molding. During this stage, the metallic frame 50 is positioned in a mold apparatus, then molten plastic material is injected into the mold apparatus. The molten plastic material envelops the metallic frame 50 except for the positioning plate 54. After a period of cooling, the molded product is taken out of the mold apparatus. After that, the positioning plate 54 is punched off from the antenna base 20 at the four connecting points 542. The housing 10 is fabricated accordingly. It is to be understood that, in this fabricating process, the positioning plate 54 can stabilize the positioning of the antenna base portion 52 within the mold apparatus.

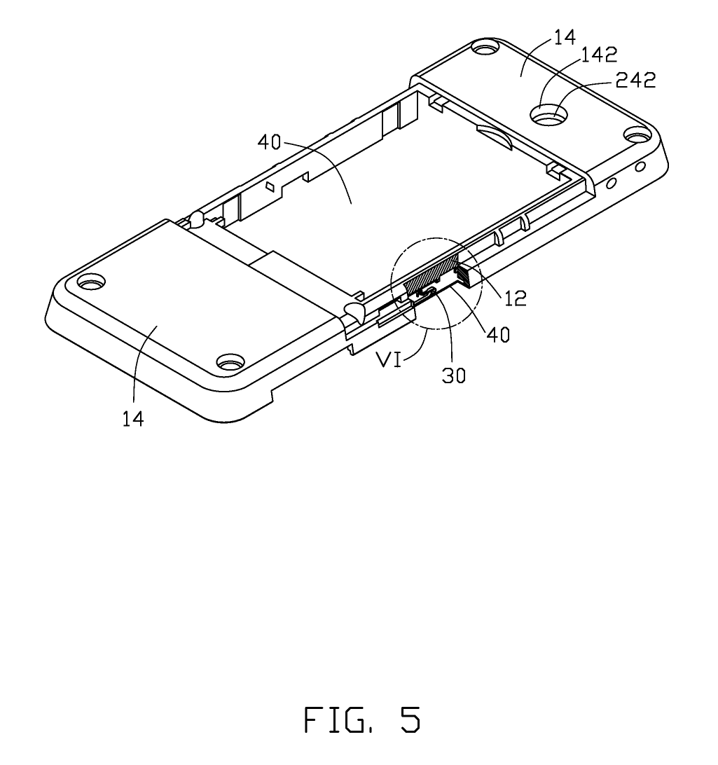

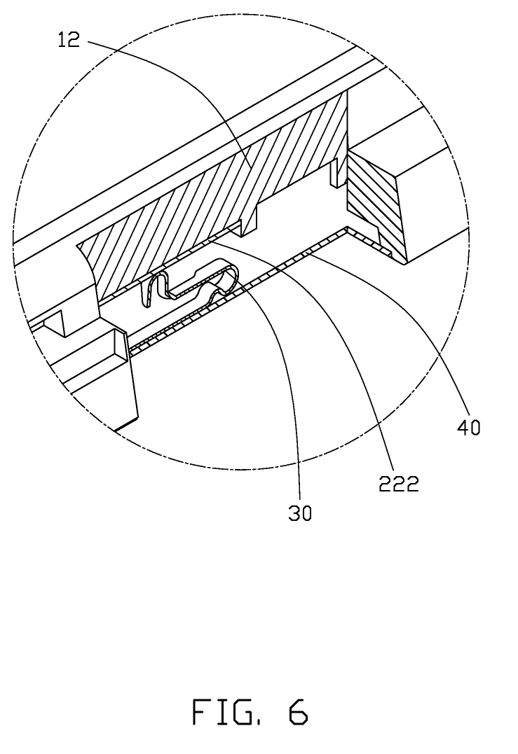

Referring next to FIGS. 5 and 6, the housing 10 is assembled with a circuit board 40. The circuit board 40 has an elastic sheet 30 attached thereon. The elastic sheet 30 deformably resists against the protruding flange 222 of the antenna base 20 and electrically connects the antenna base 20 to the circuit board 40. It can also be understood that, due to the engaging aperture 2422 aligning with the hole 142 of the housing 10, a subsidiary metallic member (not shown) can be inserted into the hole 142 and connect to the antenna base 20 to make the antenna base 20 receive and/or send telecommunication signal more easily.

It is to be understood that the positioning plate 54 can be omitted, or the positioning plate 54 can be punched off from the metallic frame 50 before the molding of the housing 10.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A housing, functioning as an antenna, comprising:
an antenna base including two protruding flanges;
wherein the housing is formed by injection molding a molten plastic material over and around the antenna base, whereby the antenna base is embedded in the housing, and the protruding flanges are exposed out of the housing.

2. The housing as claimed in claim 1, wherein the antenna base includes two extending walls and a connecting wall connecting the two extending walls, the two protruding flanges protrudes from the two extending walls respectively.

3. The housing as claimed in claim 2, wherein the housing includes two opposite sidewalls and two opposite end portions, the two extending walls are embedded into the two sidewalls respectively, each protruding flanges is exposed to the bottom of the sidewall correspondingly, and the connecting wall is embedded into one of the end portions.

4. The housing as claimed in claim 2, wherein out of the connecting wall protrudes an extending flange defining an engaging aperture therein, one of the end portions has a hole defined therein, the engaging aperture aligns with hole correspondingly.

5. A method for fabricating a housing that functions as an antenna, comprising:
providing a metallic frame including an antenna base portion and a positioning plate connecting the antenna base portion;
placing the metallic frame into a mold apparatus and injecting a molten plastic material into the mold apparatus, the molten plastic integrally combining with the metallic frame to form a molded product with the antenna base portion embedded therein, and the positioning plate being exposed out of the housing;
taking the molded product out from the mold apparatus; and
punching the positioning plate off from molded product to form the housing.

6. The method as claimed in claim 5, wherein the antenna base portion includes two protruding flanges, the two protruding flanges are exposed after the housing is formed.

7. The method as claimed in claim 6, wherein the housing includes two opposite sidewalls and two opposite end portions, the antenna base portion includes two extending walls and a connecting wall connecting the two extending walls, the two extending walls are embedded in the two sidewalls respectively, each protruding flanges is exposed in the bottom of the sidewall correspondingly, and the connecting wall is embedded in one of the end portions.

8. The method as claimed in claim 7, wherein the connecting wall protrudes an extending flange defining an engaging aperture therein, one of the end portions has a hole defined therein, the engaging aperture aligns with hole correspondingly.

9. A method for fabricating a housing that functions as an antenna, comprising providing a metallic frame including an antenna base portion and two protruding flanges;
insert molding the metallic frame into a housing with the antenna base portion being embedded therein and the two protruding flanges being exposed out of the housing;
taking out the housing.

10. The method as claimed in claim 9, wherein the antenna base portion includes two extending walls and a connecting wall connecting the two extending walls, the two protruding flanges protrudes from the two extending walls respectively.

11. The method as claimed in claim 10, wherein the housing includes two opposite sidewalls and two opposite end portions, the two extending walls are embedded in the two sidewalls respectively, each protruding flange is exposed in the bottom of the sidewall correspondingly, and the connecting wall is embedded in one of the end portions.

12. The method as claimed in claim 10, wherein the connecting wall protrudes an extending flange defining an engaging aperture therein, one of the end portions has a hole defined therein, the engaging aperture aligns with hole correspondingly.
